(19) United States
(12) Patent Application Publication
(10) Pub. No.: US 2009/0007708 A1
(43) Pub. Date: Jan. 8, 2009

(54) ROTARY CABLE ASSEMBLY FOR VEHICLES

(76) Inventor: Kwang Woon Cho, Yongin-si (KR)

Correspondence Address: MORGAN, LEWIS & BOCKIUS LLP (SF), One Market, Spear Street Tower, Suite 2800, San Francisco, CA, 94105, US

(21) Appl. No.: 11/966,158

(22) Filed: Dec. 28, 2007

(30) Foreign Application Priority Data
Jul. 6, 2007 (KR) 10-2007-0068214

(51) Int. Cl. F16H 29/00

(52) U.S. Cl. 74/89.22

(57) ABSTRACT

A rotary cable assembly to transmit force through a connection cable connected between a pair of pulleys. At least one of the pulleys includes a hollow pulley unit; and a cable holding unit in the pulley unit and rotatable therein in one direction, the holding unit including a slot, for the cable to sit therein, at its outer surface. The pulley unit is disposed is a housing.

### CROSS-REFERENCE TO RELATED APPLICATIONS

This application claims priority to Korean Application No. 10-2007-0068214, filed on Jul. 6, 2007, the disclosure of which is incorporated herein by reference.

### BACKGROUND OF THE INVENTION

1. Field of the Invention

The present invention relates to rotary cable assemblies.

2. Description of the Related Art

In manual controllers, such as those provided on vehicle instrument panels, for example, air conditioner knobs, rotation is transmitted between a drive pulley and a driven pulley through an inner cable. The inner cable is often housed in an outer cable, which is provided at one end with a compression coil spring, which biases the first and second pulleys away from each other.

There is a limit to which the tension between the two pulleys can be managed using only the compression coil spring. Furthermore, when the inner cable stretches out with use, some of the rotation of the drive pulley is not transmitted to the driven pulley.

### SUMMARY OF THE INVENTION

Disclosed is a rotary cable assembly to transmit force through a connection cable connected between a pair of pulleys. At least one of the pulleys includes a hollow pulley unit; and a cable holding unit in the pulley unit and rotatable therein in one direction, the holding unit including a slot, for the cable to sit therein, at its outer surface. The pulley unit is disposed is a housing.

One-way gear teeth are provided on an inner surface of the pulley unit, engaged on one-way gear teeth on the outer surface of the cable holding unit.

The cable holding unit includes a cable holding body on an outer surface of which the one-way gear teeth are provided. The cable holding unit also includes a handle for rotation of the cable holding body, and a locking hook provided on the cable holding body. The locking hook serves as a rotating shaft of the cable holding unit.

The pulley unit has a seating depression, with the cable holding unit seated therein.

The pulley unit has a first cable guide slot to guide the connection cable in a radial direction, and a second cable guide slot around its outer surface to guide the connection cable in a circumferential direction.

The cable holding body includes a cable connection slot extending radially from its central portion.

A cable support block is provided in the housing to support and guide retraction of the connection cable into the housing.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a rotary cable assembly for vehicles according to an embodiment of the present invention;

FIG. 2 is a flowchart illustrating assembly of the rotary cable assembly of FIG. 1;

FIG. 3 is a sectional view taken along line A-A of FIG. 2;

FIG. 4 illustrates a non-operating state of the rotary cable assembly of FIG. 1; and

FIG. 5 illustrates an operating state of the rotary cable assembly of FIG. 1.

### DESCRIPTION OF THE PREFERRED EMBODIMENTS

Hereinafter, a preferred embodiment of the present invention will be described in detail with reference to the attached drawings.

Embodiments of the present invention provide a rotary cable assembly that applies an appropriate degree of tension to a connection cable 400, which connects two pulleys to each other, when the connection cable 400 stretches out with use, preventing loss of output. The assembly may be provided to one or both pulleys.

The pulley or pulleys provided with the assembly each includes a hollow pulley unit 100, which has one-way internal gear teeth 110 therein; a cable holding unit 200, to which one end of the connection cable 400 is held, and whose outer surface engages with the one-way internal gear teeth 110; and a housing 300, in which the pulley unit 100 is fastened.

The pulley unit 100 is generally a circular plate, with the connection cable 400 wound around it.

A seating depression 270, into which the cable holding unit 200 is seated, is provided in the pulley unit 100. The one-way internal gear teeth 110 are disposed on the inner surface of the pulley unit 100, and have a sawtooth shape, oriented in one direction. The one-way internal gear teeth 110 engage with one-way external gear teeth 210 of the cable holding unit 200, and thus ensure one-way rotation of the cable holding unit 200.

A first cable guide slot 121 is provided in the radial direction of the pulley unit 100 to guide the portion of the connection cable 400 that is connected to the cable holding unit 200. A second cable guide slot 122 is provided around the outer surface of the pulley unit 100 to guide the connection cable 400 that extends circumferentially from the first cable guide slot 121.

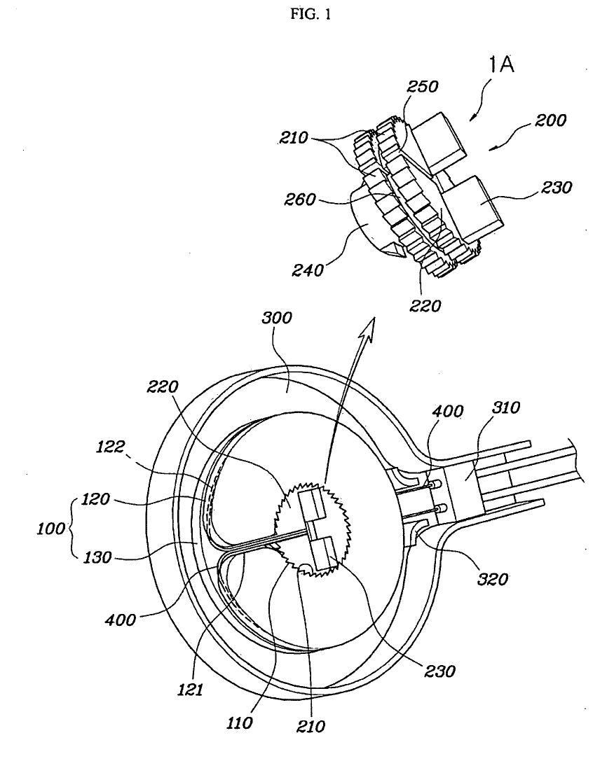

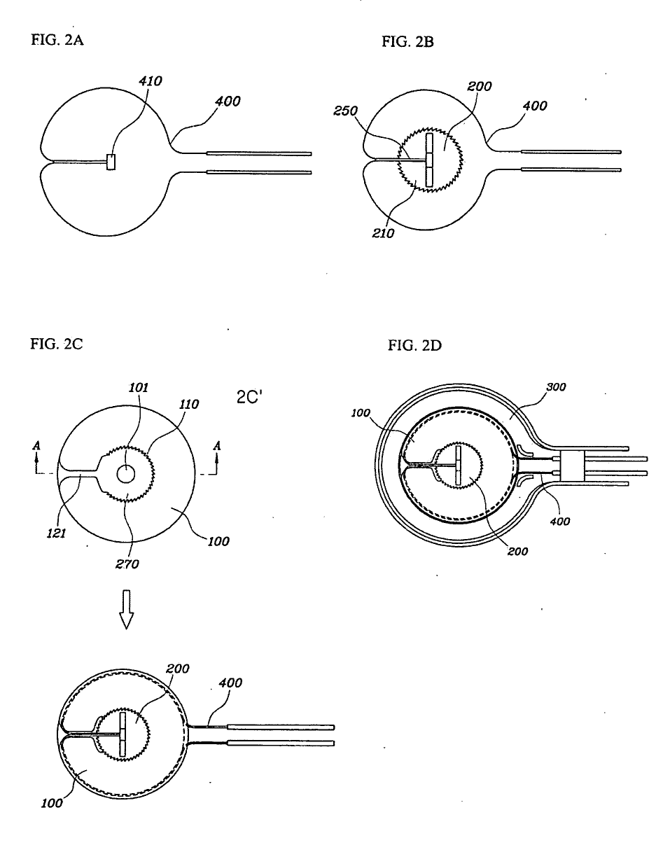

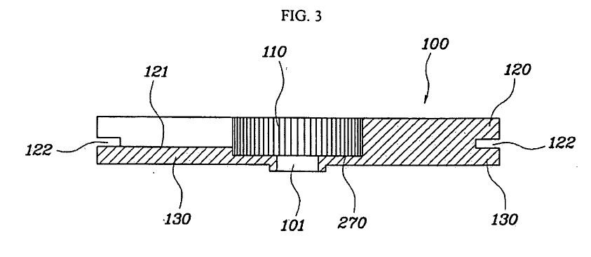

A locking hook 240 (FIG. 1A) of the cable holding unit fastens the cable holding unit 200 to the pulley unit 100. An insert hole 101 (FIGS. 2C′ and 3), into which the locking hook 240 is fitted, is provided through a second pulley body 130 (FIGS. 1 and 3) of the pulley unit 100. Therefore, the cable holding unit 200 is rotatable around the locking hook 240 in one direction, using engagement between the tooth 110 and 210.

Referring especially to FIG. 3, the pulley unit 100 may generally be made up of a first pulley body 120 and the second pulley body 130, disposed at either side of the second cable guide slot 122.

The cable holding unit 200 may be die-cast, and holds a holding piece 410 (FIG. 2) coupled to the end of the connection cable 400. When the cable holding unit 200 is rotated, tension is applied to the connection cable 400.

As illustrated in FIG. 1A, the cable holding unit 200 includes a cable holding body 220, which is seated in the seating depression 270 of the pulley unit 100 and has the teeth 210 on the outer surface thereof; a handle 230, which protrudes from the cable holding body 220, enabling rotation of the cable holding body 220; and the locking hook 240.

In more detail, referring still to FIG. 1A, the cable holding body 220 has two rows of teeth 210. A slot 260 is provided between the two rows, so that, when the cable holding body 220 is rotated, the connection cable 400 is wound around the slot 260.

Particularly, the holding piece 410 of the connection cable 400 is fastened to the central portion of the cable holding body 220. Furthermore, a cable connection slot 250, which extends radially from the central portion of the cable holding body 220, is provided to guide the connection cable 400 to the cable guide slot 121 of the pulley unit 100.

The pulley unit 100 is supported by a housing 300. To fasten the pulley unit 100 to the housing 300, a separate hook may be used, or, alternatively, the locking hook 240 may be used. As a further alternative, a bonding agent may be used.

A cable guide passage, through which the connection cable 400 is drawn into the housing 300, is provided in the housing 300 adjacent to the cable holding unit 200. A cable support block 310 (FIGS. 1, 4, and 5), which holds the connection cable 400 and guides it into the housing 300, is installed in the cable guide passage. Guide pieces 320 are provided in the housing 300 at positions adjacent to the inlet of the cable guide passage to guide the connection cable 400 towards the cable holding unit 200.

Therefore, the connection cable 400 extends along the first cable guide slot 121 of the pulley unit 100 under the guidance of the guide pieces 320, and is fastened to the cable holding body 220 through the cable connection slot 250.

Hereinafter, an exemplary process of assembling the above-described rotary cable assembly will be described with reference to FIG. 2. The assembly is conducted in the sequence of FIGS. 2A, 2B, 2C and 2D. FIG. 2C illustrates the combination of FIGS. 2B and 2C′.

The holding piece 410 is fastened to the end of the connection cable 400, such as through die-casting.

Thereafter, the holding piece 410 is fitted into the cable holding unit 200. The cable connection slot 250 guides the direction of the connection cable 400.

The pulley unit 100 is prepared, and the cable holding unit 200 is fitted into the pulley unit 100. The locking hook 240 of the cable holding unit 200 is inserted into the insert hole 101 of the pulley unit 100, and the teeth 120 are engaged with the teeth 110.

Subsequently, the pulley unit 100 is fastened to the housing 300. Thereafter, the cable support block 310 is provided in the housing 300.

The operation of the above-described assembly will be explained herein below.

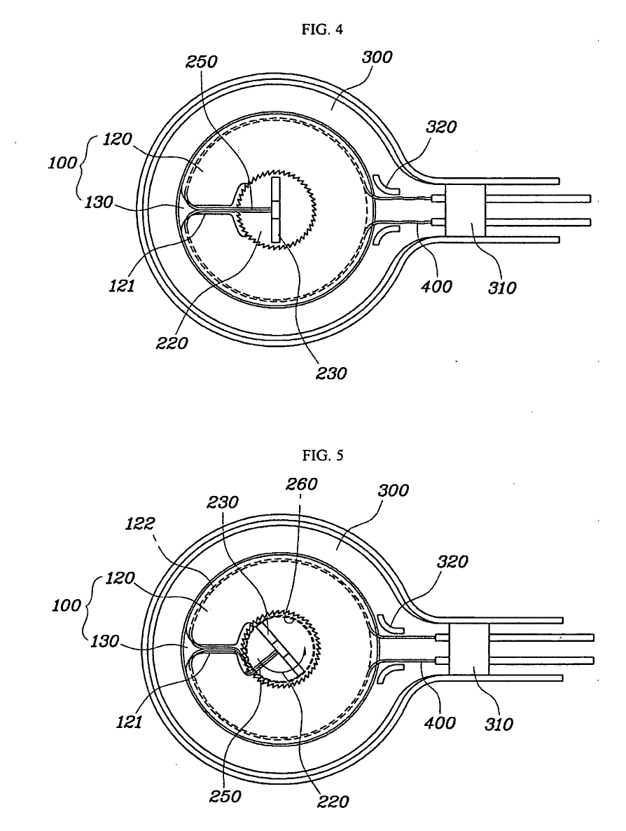

As shown in FIG. 4, under normal conditions, the teeth 110 engage with the teeth 210. Thus, the rotary cable assembly is rotatable only in one direction.

However, in the case where the connection cable 400 is stretched out with use, as shown in FIG. 5, when the handle 230 is rotated in one direction to apply appropriate tension to the connection cable 400, the teeth 210 pass by the teeth 110, so that the cable holding unit 200 is rotated in the cot-responding direction with respect to the pulley unit 100.

The end of the connection cable 400 is rotated along with the cable holding unit 200, so that part of the connection cable 400 is wound around the cable holding unit 200. Thereby, the connection cable 400, which was loose, is pulled taught.

Since manual control knobs generally have an operational range of motion of ˜180°, the fact that the end of the cable 400 near the holding piece 410 is locked in to rotational alignment with the cable holding unit 200 does not affect operation of the assembly.

Although preferred embodiments of the present invention have been disclosed for illustrative purposes, those skilled in the art will appreciate that various modifications, additions and substitutions are possible, without departing from the scope and spirit of the invention as defined in the accompanying claims.

What is claimed is:

1. A rotary cable assembly to transmit force through a connection cable connected between a pail of pulleys, wherein at least one pulley of the pair of pulleys comprises:
a hollow pulley unit;
a cable holding unit provided in the pulley unit so as to be rotatable in one direction with respect to the pulley unit, comprising a slot at an outer surface thereof configured for the cable to sit therein; and
a housing in which the pulley unit is disposed.

2. The rotary cable assembly as set forth in claim 1, further comprising first one-way gear teeth provided on an inner surface of the pulley unit and second one-way gear teeth provided on the outer surface of the cable holding unit and engaged with the first one-way gear teeth.

3. The rotary cable assembly as set forth in claim 2, wherein the cable holding unit comprises a cable holding body comprising the second one-way gear teeth on an outer surface thereof, a handle for rotation of the cable holding body; and a locking hook provided on the cable holding body, the locking hook serving as a rotating shaft of the cable holding unit.

4. The rotary cable assembly as set forth in claim 1, wherein the pulley unit comprises a seating depression, with the cable holding unit seated therein.

5. The rotary cable assembly as set forth in claim 1, wherein the pulley unit comprises a first cable guide slot to guide the connection cable in a radial direction of the pulley unit and a second cable guide slot around an outer surface of the pulley unit to guide the connection cable in a circumferential direction of the pulley unit.

6. The rotary cable assembly as set forth in claim 3, wherein the cable holding body comprises a cable connection slot extending from a central portion of the cable holding body in a radial direction.

7. The rotary cable assembly as set forth in claim 1, further comprising a cable support block provided in the housing to support and guide retraction of the connection cable into the housing.
